(19) United States
(12) Patent Application Publication
(10) Pub. No.: US 2026/0006138 A1
(43) Pub. Date: Jan. 1, 2026

(54) IMAGE READING APPARATUS AND IMAGE FORMING APPARATUS

(71) Applicant: CANON KABUSHIKI KAISHA, Tokyo (JP)

(72) Inventor: SATOSHI TAKEMOTO, Ibaraki (JP)

(21) Appl. No.: 19/202,529

(22) Filed: May 8, 2025

(30) Foreign Application Priority Data
Jun. 26, 2024 (JP) 2024-102604

(51) Int. Cl. H04N 1/00; G03G 15/22

(52) U.S. Cl. CPC H04N 1/00559; G03G 15/228; H04N 1/00525; H04N 2201/0081

(57) ABSTRACT

Disclosed is an image reading apparatus including: a reading unit for reading a document placed on a transparent plate while moving in a scanning direction; a holding member for holding the reading unit; a guide shaft for supporting the holding member such that the holding member can move in the scanning direction; a housing for accommodating the reading unit and the guide shaft, the transparent plate being placed on an upper surface of the housing; and a grounding member for grounding the guide shaft by being in contact with the guide shaft. The holding member includes a sliding portion that fits to the guide shaft and is slidable in the scanning direction with respect to the guide shaft, the sliding portion having a groove-like shape whose lower portion is opened. The grounding member is in contact with the guide shaft in an opened portion of the sliding portion.

### BACKGROUND

### Field of the Technology

This disclosure relates to an image reading apparatus which reads an image of a document placed on a document base by scanning it and an image forming apparatus with this image reading apparatus.

### Description of the Related Art

Conventionally known is an image reading apparatus and an image forming apparatus with the configuration in which an image is read while a reading unit moving along a metal guide shaft.

Japanese Patent Application Laid-open No. 2005-017873 discloses the configuration in which the end portion of the metal guide shaft which supports the reading unit and guides it in the sub-scanning direction is grounded to a metal reinforcing plate located on an end portion of the housing by fitting it to the shaft supporting portion having a grounding member.

However, when adding a grounding member at the end portion of the guide shaft, a space for disposing the grounding member in the axial direction of the guide shaft is required, so that there is a problem that the external size of the image reading apparatus becomes large.

### SUMMARY

Therefore, the present disclosure is directed to ground the guide shaft without the external size of the image reading apparatus becoming larger.

A representative configuration of the present disclosure is an image reading apparatus comprising:
a transparent plate on which a document is placed;
a reading unit configured to read the document placed on the transparent plate while moving in a scanning direction;
a holding member configured to hold the reading unit;
a guide shaft configured to support the holding member such that the holding member can move in the scanning direction;
a housing configured to accommodate the reading unit and the guide shaft, the housing being made from resin, the transparent plate being placed on an upper surface of the housing; and
a grounding member configured to ground the guide shaft by being in contact with the guide shaft,
wherein the holding member includes a sliding portion that fits to the guide shaft and is slidable in the scanning direction with respect to the guide shaft, the sliding portion having a groove-like shape whose lower portion in a vertical direction is opened, and
wherein, as viewed in the scanning direction, the grounding member is in contact with the guide shaft in an opened portion of the sliding portion.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus including an image reading apparatus.

FIG. 2 is a schematic diagram showing the configuration of the image reading apparatus.

FIG. 3 is a plan view of the main body of the image reading apparatus.

FIG. 4 is a schematic diagram showing an internal configuration of the image reading apparatus.

FIG. 5 is a diagram showing the grounding configuration of the image reading apparatus.

FIG. 6 is a diagram showing a cross-sectional view of a contact portion of a guide shaft and a grounding spring.

### DESCRIPTION OF THE EMBODIMENTS

Hereinafter, with reference to the drawings, a preferred embodiment of the present disclosure will be exemplarily described in detail. However, the dimensions, materials, shapes and relative positions of the components described in the following embodiment are not intended to limit the scope of the disclosure only to them.

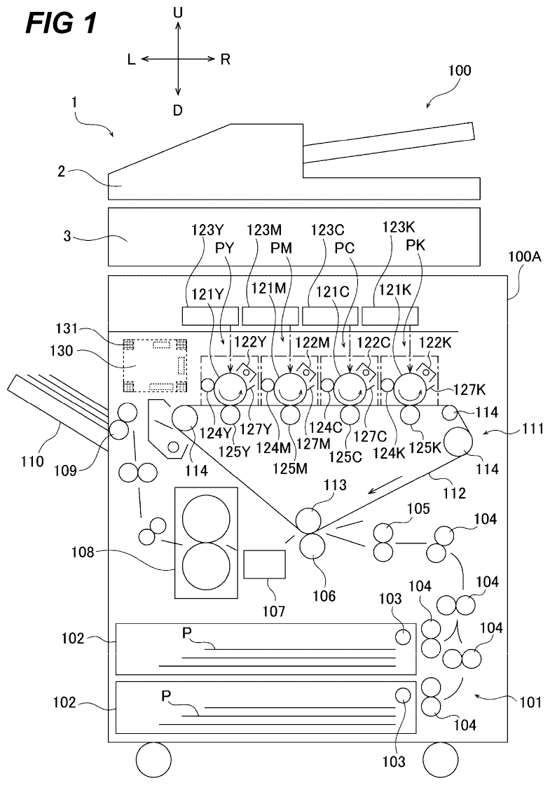

(Image Forming Apparatus) The schematic configuration of the image forming apparatus 100 provided with the image reading apparatus 1 will be described with reference to FIGS. 1 to 3. FIG. 1 is a diagram showing a cross-sectional view of the image forming apparatus 100 including the image reading apparatus 1. The image forming apparatus 100 is exemplified as a copying machine and is provided with the apparatus main body 100A and the image reading apparatus 1 provided on the upper portion of the apparatus main body 100A.

The image forming apparatus 100 shown in FIG. 1 is a color image forming apparatus with intermediate transfer tandem system, wherein the image forming units PY, PC, PM and PK for four colors (yellow, cyan, magenta and black) are opposed to the intermediate transfer belt 112 in the apparatus main body 100A.

The image forming apparatus 100 is provided with the image forming units PY to PK that form a toner image on the photosensitive drum 121, the intermediate transfer unit 111 having the intermediate transfer belt 112 that bears the toner image formed on the photosensitive drum 121, and the sheet feeding portion 101 that feeds the sheet P. In the present embodiment, the image forming units PY to PK, the primary transfer rollers 125Y to 125K, the intermediate transfer belt 112, the secondary transfer inner roller 113 and the secondary transfer outer roller 106 constitute an image forming portion that forms a toner image on the sheet P. The intermediate transfer unit 111 is constituted by the intermediate transfer belt 112 that is an endless belt, the stretching roller 114 that stretches the intermediate transfer belt 112, and the secondary transfer inner roller 113. Further, the sheet feeding portion 101 is constituted by the sheet feeding cassettes 102, the sheet feeding rollers 103, the conveying roller pairs 104, the registration roller pair 105.

The sheets P accommodated in each of the sheet feeding cassettes 102 are fed one by one by the corresponding sheet feeding roller 103 and conveyed to the registration roller pair 105 by the conveying roller pair 104. The registration roller pair 105 adjusts the skew feeding by stopping the leading end of the sheet P and restarts the conveyance of the sheet P in accordance with the progression of the imaging operation that is a forming process of a toner image by the image forming portion.

The image forming unit PY has photosensitive drum 121Y that is a photosensitive member, the charging device 122Y, and the developing device 124. A round the photosensitive drum 121Y, the charging device 122Y, the exposing device 123Y, the developing device 124Y, the primary transfer roller 125Y, and the cleaner 127Y are disposed. The other image forming units PM, PC and PK have the same configuration as that of the image forming unit PY except for the toner color, so the detailed description will be omitted.

The charging device 122Y uniformly charges the surface of the photosensitive drum 121Y and the exposing device 123Y exposes the photosensitive drum 121Y based on the image information input from the image reading apparatus 1, so that an electrostatic latent image is formed on the photosensitive drum 121Y. The developing device 124Y supplies toner to the photosensitive drum 121Y to develop the electrostatic latent image into a toner image.

The toner image borne on each photosensitive drum 121 is transferred to the intermediate transfer belt 112 in a superimposing manner by the corresponding primary transfer roller 125. The toner image transferred on the intermediate transfer belt 112 in a superimposing manner is transferred on the sheet P conveyed from the registration roller pair 105 by the second transfer outer roller 106. The sheet P on which the toner image has been transferred is conveyed towards the fixing unit 108 by the conveying unit 107. The adhering substance such as toner remaining on the photosensitive drum 121 without being transferred onto the sheet P is removed by the cleaner 127, so that the photosensitive drum 121 is ready for the next imaging operation.

The sheet P conveyed to the fixing unit 108 is pressurized and heated while being nipped by the roller pair, so that the image is fixed on the sheet P by melting and adhesion of the toner. The sheet P on which the image has been fixed is discharged by the discharge roller pair 109 to the discharge tray 110 that protrudes outside the apparatus main body 100A.

The above described image forming apparatus 100 is configured to be controlled by the control unit 130. The control unit 130 has a control circuit board with a CPU.

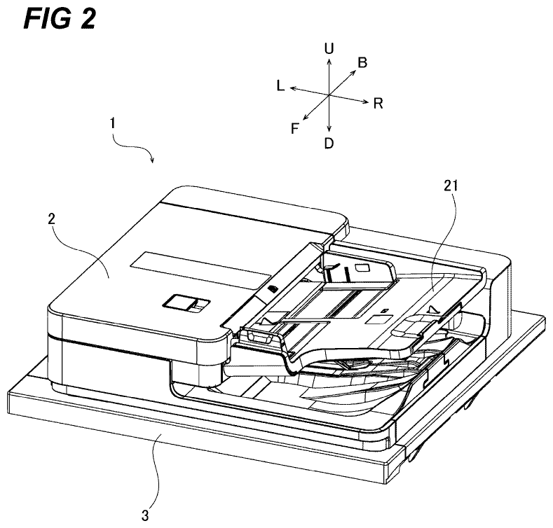

(Image Reading Apparatus) Next, the schematic configuration of the image reading apparatus 1 will be described. FIG. 2 is a schematic diagram of image reading apparatus 1 according to the present embodiment. The image reading apparatus 1 is provided with the reading apparatus main body 3, the automatic document feeder (hereinafter referred to as ADF unit) 2. Further, the image reading apparatus 1 is provided with the scanning unit 41 as the image reading portion disposed in the reading apparatus main body 3.

The image reading apparatus 1 is configured to automatically convey a document (not shown) placed on the document placing tray 21 by a user. The document is a sheet to be read of paper such as an envelope, a plastic film for overhead projector (OHP), and cloth. The image reading apparatus 1 reads an image of a document. Specifically, the image reading apparatus 1 is configured to receive the reflected light of the light with which the conveyed document at the image reading position is irradiated, to optically read the image on the document, to convert it into an electrical signal, and to prepare image data (image reading information) based on the electrical signal.

Next, the elements of the image reading apparatus 1 will be described.

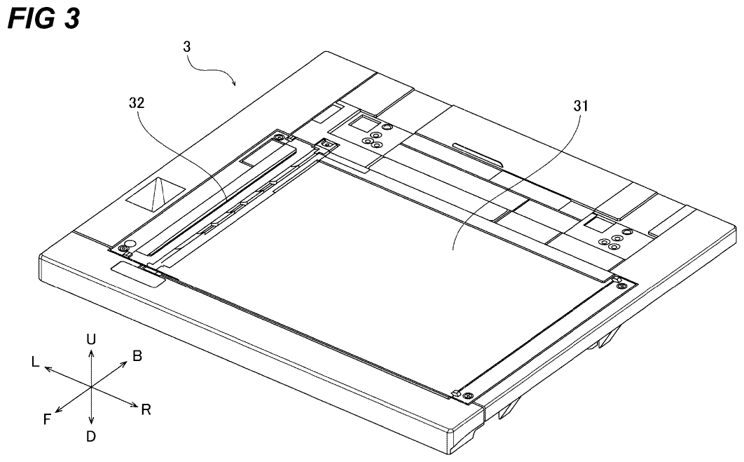

The reading apparatus main body 3 is fixed on the upper surface of the apparatus main body 100A (see FIG. 1). On the upper surface of the reading apparatus main body 3, the document basis glass 31 (transparent plate) of flat-bed type is disposed as shown in FIG. 3. The scanning unit 41 (reading unit) is an image reading portion that reads image information from the document. The image data read by the scanning unit 41 is output to the control unit 130 of the apparatus main body 100A.

The scanning unit 41 is provided with a light source (not shown) for irradiating the document placed on the document basis glass 31 and a photoelectric conversion portion (not shown) that photoelectrically converts the reflected light from the document. The scanning unit 41 is supported by the unit holder 42 that is movable in the direction shown by the arrow S (scanning direction, leftward/rightward directions). The unit holder 42 is an example of the holding portion that holds the scanning unit 41. The unit holder 42 is connected to the motor unit 44 as the driving unit by the timing belt 45 stretched in the direction shown by arrow S and is moved in the direction shown by arrow S along the document basis glass 31 by the rotation of motor unit 44.

The ADF unit 2 is supported by the hinge mechanism (not shown) disposed on the back side in the figure such that the ADF unit 2 can be opened and closed in the upward and downward directions with respect to the reading apparatus main body 3. On the ADF unit 2, a pressing portion (not shown) that presses the document placed on the document basis glass 31 against the document basis glass 31 is formed. The ADF unit 2 is further provided with the document placing tray 21 and a document feeding portion (not shown). The document placing tray 21 supports the document placed by a user. The document feeding portion (not shown) is provided with a conveying guide that guides the document and a sheet feeding roller that feeds the document, so that the document placed on the document placing tray 21 is fed to the scanning unit 41 that is stopped in the reading position by the sheet feeding roller.

The image reading apparatus 1 as configured above reads image information from the document through the flow reading mode in which a document image is scanned while the document is fed by the ADF unit 2 and the fixed reading mode in which the document placed on the document basis glass 31 is scanned.

The fixed reading mode is selected when the document placed on the document basis glass 31 and positioned by a pressing portion (not shown) of the ADF unit 2 is detected by a detecting portion (not shown) or when a user explicitly instructs through an operation portion (not shown) of the apparatus main body 100A. In this case, the scanning unit 41 reads the image on the document placed on the document basis glass 31 while moving in the scanning direction along the document basis glass 31.

Specifically, while being moved along the document basis glass 31 by the unit holder 42, the scanning unit 41 irradiates the document with light from the light source, images the reflected light from the document at photoelectric conversion portion by lens. The photoelectric conversion portion photoelectrically converts the imaged reflected light into an electrical signal and outputs it. The scanning unit 41 reads the image information of the document as described above.

In the present embodiment, the scanning unit 41 adopts a CIS (Contact Image Sensor) unit with the equal-magnification optical system. The image information that is photoelectrically converted according to the image density of the document is converted from an analog signal to a digital signal at the AFE (Analog Front End). In the present embodiment, the AFE is implemented in the scanning unit 41.

In contrast, the flow reading mode is selected when the document placed on the document placing tray 21 is detected by a detecting portion (not shown) or when a user explicitly instructs through an operation portion (not shown) of the apparatus main body 100A. In this case, the scanning unit 41 is moved to the reading position (position of flow reading glass 32 shown in FIG. 3) by the unit holder 42 and stopped there. Then, the ADF unit 2 feeds the documents one by one towards the reading position in which the scanning unit 41 is stopped. The scanning unit 41 that has been stopped in the reading position reads the image on the document fed to the reading position. The read image data are transferred to the control unit 130 of the apparatus main body 100A.

The upward direction U, the downward direction D, the rightward direction R, the leftward direction L, the backward direction B, and the forward direction F shown in FIG. 1 are defined as blow. With respect to the image forming apparatus 100, the side on which the operation portion (not shown) is provided is defined as front side and the side opposite to the front side, where the hinge mechanism (not shown) of the image reading apparatus 1 is disposed is defined as back side. In FIG. 1, the direction from the back side to the front side of the drawing sheet is defined as the forward direction F, the direction from the front side to the back side of the drawing sheet is defined as the backward direction B. With respect to the image forming unit PK for forming a black image, the side on which the image forming unit PY for forming a yellow image is disposed is defined as left side. With respect to the image forming unit PY for forming a yellow image, the side on which the image forming unit PK for forming a black image is disposed is defined as right side. The upward direction in the vertical directions that is perpendicular to the forward/backward directions and the rightward/leftward directions defined above is defined as upward direction U. The downward direction in the vertical directions that is perpendicular to the forward/backward directions and the rightward/leftward directions defined above is defined as downward direction D.

The scanning directions (first directions) of the scanning unit 41 are defined as rightward/leftward directions. The second directions perpendicular to the first directions are defined as forward/backward directions. The third directions perpendicular to the first directions and the second directions are defined as upward/downward directions.

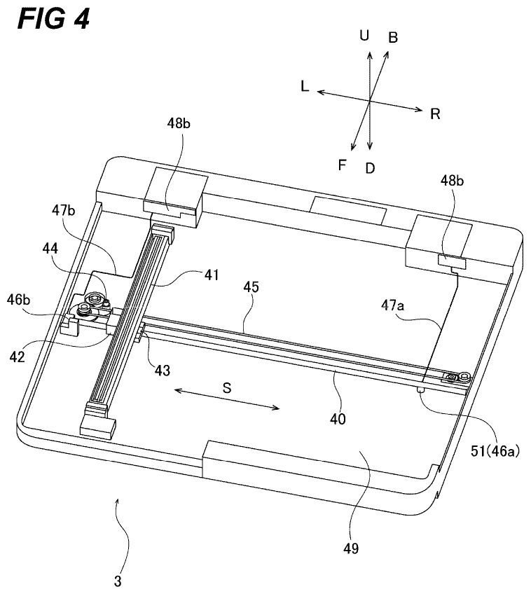

(Reading Apparatus Main Body) The configuration of the reading apparatus main body 3 will be described in detail with reference to FIGS. 4 to 6. FIG. 4 is a schematic drawing showing the internal configuration of the reading apparatus main body 3.

The reading apparatus main body 3 is provided with the guide shaft 40, the bearing portion 43, the housing 49 made from resin, the grounding springs (grounding members) 46a and 46b in addition to the above described scanning unit 41 and the unit holder 42.

As described above, in the fixed reading mode, the scanning unit 41 scans and reads in the scanning direction the document disposed on the document basis glass 31. In contrast, in the flow reading mode, the scanning unit 41 is stopped in the reading position (position of the flow reading glass 32 shown in FIG. 3) and reads the image of the document fed to the reading position.

The guide shaft 40 is extended in the scanning directions (leftward/rightward directions), and movably supports the scanning unit 41, and guides the scanning unit 41 in the scanning directions. The guide shaft 40 is made of metal.

The housing 49 is made of resin and has such a configuration as to be able to ensure the rigidity. The housing 49 adopts resin as material in order to reduce the product cost. The housing 49 accommodates the scanning unit 41 and the guide shaft 40 and on the top surface of the housing 49, the document basis glass 31 is disposed.

To the unit holder 42 that holds the scanning unit 41, the bearing portion 43 is attached. The bearing portion 43 has the groove-like shape in which a part (in down ward direction in the vertical directions) is opened. The bearing portion 43 fits to the guide shaft 40 by the groove-like shape. The bearing portion 43 is configured to hold the guide shaft 40 and to be slidable in the scanning direction (direction shown by arrow S in FIG. 4) while being guided by the guide shaft 40. Namely, the unit holder 42 has the bearing portion 43 as a sliding position that fits to the guide shaft 40 and is slidable in the scanning direction with respect to the guide shaft 40. The bearing portion (sliding portion) 43 of the unit holder 42 is exemplified as having the groove-like shape whose lower portion (in the vertical directions) is opened. However, the configuration is not limited to this one. A part of the bearing portion (sliding portion) 43 other than the lower portion (in the vertical directions) may be opened as long as the bearing portion (sliding portion) 43 has a groove-like shape in which a part of the bearing portion (sliding portion) 43 is opened.

As described above, the AFE is implemented in the scanning unit 41. In order to realize high speed operation of image reading of the scanning unit 41, the AFE works at a high speed with the internal clock of about 200 MHz. With this high speed operation, interference waves are generated from the scanning unit 41. The interference waves would be electromagnetically coupled to the metal guide shaft 40, so that the interference waves would be emitted outside the reading apparatus main body 3. It is required that the emitted interference waves should be suppressed such that they are below the regulation value of EMC.

In order to suppress the interference waves from being emitted, the guide shaft 40 is grounded by the grounding springs 46a and 46b being connected to the grounding points 48a and 48 via the contact point connection portions 47a and 47b, respectively. The above described control unit (control circuit board) 130 has the ground point 131 as the reference potential (ground potential). The ground points 131 of the control unit 130 of the apparatus main body 100A are electrically connected to the ground points 48a and 48b of the reading apparatus main body 3. Namely, the guide shaft 40 is grounded by the grounding springs 46a and 46b as grounding members being brought in contact with the guide shaft 40.

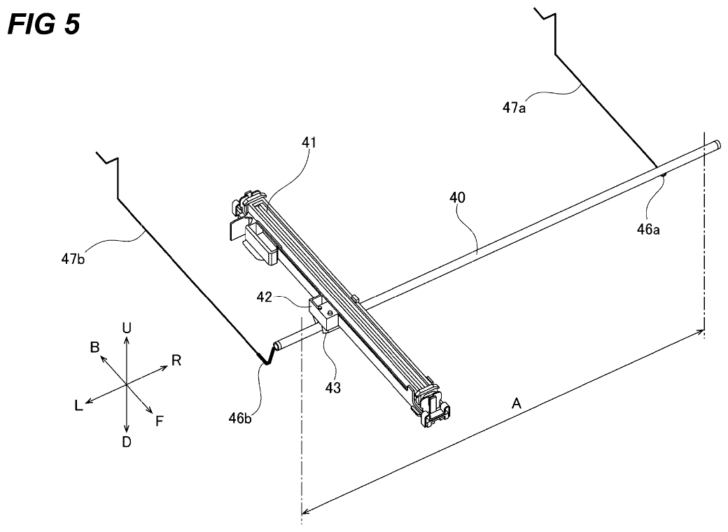

FIG. 5 is a diagram showing the grounding configuration of the reading apparatus main body 3 and in which the configurations for grounding of the scanning unit 41 and the guide shaft 40 are extracted. In the present embodiment, the guide shaft 40 is grounded at two points of the grounding springs 46a and 46b.

In this embodiment, the configuration is exemplified in which two ground springs 46a and 46b are in contact with the guide shaft 40, so that two points of the guide shaft 40 are grounded. However, the configuration is not limited to this one. Other configurations may be adopted in which only one grounding member is in contact with the guide shaft 40 or three or more grounding members are in contact with the guide shaft 40.

The grounding spring 46a is a helical compression spring (torsion coil spring) made of metal. The grounding spring 46a is pressed against and in contact with the side surface of the guide shaft 40, so that the grounding spring 46a is electrically connected to the guide shaft 40.

Viewed in the scanning direction, the grounding spring 46a is a first grounding member that is in contact with the surface along the scanning direction of the guide shaft 40 in the opened portion of the bearing portion 43, so that the guide shaft 40 is grounded.

In contrast, the grounding spring 46b is a plate spring made of metal. The grounding spring 46b is pressed against and in contact with the end portion of the guide shaft 40, so that the grounding spring 46b is electrically connected to the guide shaft 40. The grounding spring 46b is a second grounding member that is in contact with one end surface of the guide shaft 40 in the scanning direction, so that the guide shaft 40 is grounded.

The arrow A in FIG. 5 indicates a scanning region of the scanning unit 41. The grounding spring 46b is disposed outside the scanning region of the scanning unit 41. Namely, the grounding spring 46b is in contact with the one end surface of the guide shaft 40 in the scanning direction outside the scanning region in which the scanning unit 41 scans and reads the document.

In the present embodiment, the motor unit 44 as the driving unit is provided at one end portion side in the longitudinal direction of the guide shaft 40 and accommodated in the housing 49. As a result, the installing space can be ensured in which the grounding spring 46b is in contact with the end surface of the guide shaft 40 on the motor unit 44 side (driving unit side).

In contrast, the grounding spring 46a is disposed within the scanning region of the scanning unit 41. Namely, the grounding spring 46a is in contact with the surface along the scanning direction of the guide shaft 40 within the scanning region in which the scanning unit 41 scans and reads the document.

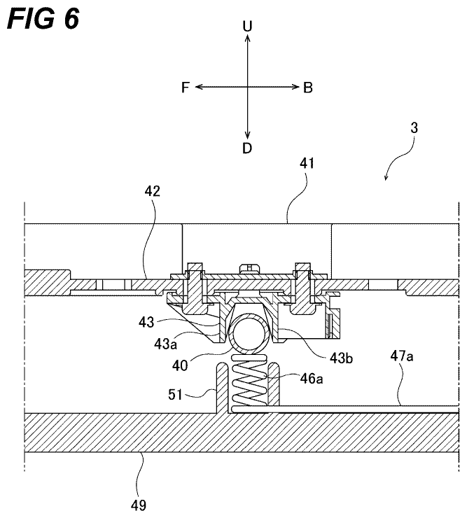

FIG. 6 is a diagram showing a cross-sectional view of the contact portion between the guide shaft 40 and the grounding spring 46a. The bearing portion 43 is configured to hold the guide shaft 40 and to be slidable while being guided by the guide shaft 40 as described above.

The opposing portions 43a and 43b of the bearing portion 43 are opposed to each other via the guide shaft 40 and are separated from each other such that the surface along the scanning direction of the guide shaft 40 is opened.

Specifically, the bearing portion 43 has the first opposing portion 43a and the second opposing portion 43b that is opposed to the first opposing portion 43a via the guide shaft 40 and is separated from the second opposing portion 43b such that the surface along the scanning direction of the guide shaft 40 is opened.

As shown in FIG. 6, in the cross-section of the guide shaft 40, the lower part of the bearing portion 43 is opened. Viewed from the axial direction (scanning direction) of the guide shaft 40, the grounding spring 46a is in contact with the guide shaft 40 in the opened portion of the bearing 43. The surface along the scanning direction of the guide shaft 40 is opened between the first opposing portion 43a and the second opposing portion 43b. The grounding spring 46a is in contact with the surface along the scanning direction of the guide shaft 40 that is opened between the first opposing portion 43a and the second opposing portion 43b. In this embodiment, the configuration is exemplified in which the lower portion of the bearing portion 43 is opened (separated). However, the configuration is not limited to this one.

By configuring as above, when the bearing portion 43 slides in the scanning direction while being guided by the guide shaft 40, the bearing portion 43 does not interfere with the grounding spring 46a that is in contact with the guide shaft 40. Therefore, even within the scanning region of the scanning unit 41, the grounding spring 46a and the guide shaft 40 is able to be grounded.

As described above, in the present embodiment, a grounding member is not provided on the end surface on the opposite side of the grounding spring 46a of the guide shaft 40 and the grounding spring 46a is disposed within the scanning region of the scanning unit 41. As a result, the present embodiment suppresses the interference waves by grounding the guide shaft 40 without making larger the external size of the image reading apparatus 1 having the housing 49 made of resin as compared with the configuration in which grounding members are disposed at both end portions of the guide shaft 40.

Further, as described above, the grounding spring 46a is a helical compression spring made of metal. By the grounding spring 46a being in contact with the guide shaft 40 while being pressed by the housing 49 and the guide shaft 40, the grounding spring 46a is electrically connected to the guide shaft 40. In order for the electrical connection not to be unstable even if the vibration is generated accompanied with the scanning of the scanning unit 41, the grounding spring 46a is preferably pressed to the guide shaft 40 with a predetermined force of 1 [N] as a rough standard.

The grounding spring support portion 51 is provided as a support member that supports the grounding spring 46a. The grounding spring support portion 51 is provided integrally with the housing 49 inside the housing 49. The grounding spring support portion 51 annularly surrounds the grounding spring 46a and the upper portion of the grounding spring support portion 51 are opened. Namely, the grounding spring support portion 51 restricts the grounding spring 46a pressed by the guide shaft 40 from being tilted such that the contact between the grounding spring 46a and the guide shaft 40 is not released. As a result, even if the grounding spring 46a is elastically deformed due to vibrations, the contact between the grounding spring 46a and the guide shaft 40 is maintained, so that the electrical connection is kept.

The grounding spring support portion 51 is provided between the guide shaft 40 and the bottom surface of the housing 49 in the upward and downward directions. Further, the grounding spring support portion 51 is provided within the range of scanning region of the scanning unit 41 in the leftward and rightward directions. Furthermore, between the grounding spring support portion 51 and the bearing portion 43 in the upward and downward directions, a predetermined gap is provided. This predetermined gap is for avoiding the bearing 43 that is sliding according to the scanning of the scanning unit 41 from being collided with the grounding spring support portion 51.

The contact point connection portion 47a is formed integrally with the grounding spring 46a using a metal wire.

In the embodiment described above, although the grounding spring 46a is described as a helical compression spring made of metal, the grounding spring 46a may be configured as a metal plate spring. Further, although the grounding spring 46b is described as a metal plate spring, the grounding spring 46b may be configured as a helical compression spring made of metal. Furthermore, the grounding springs 46a and 46b may be configured by an elastic member having electric conductivity such as a gasket (sponge member having electric conductivity on the surface) and resin having electric conductivity.

In the above described embodiment, although the contact point connection portion 47a is described to be formed integrally with the grounding spring 46a using a metal wire, the configuration is not limited to this one. It is sufficient that the contact point connection portion 47a is a member having electric conductivity such as a metal plate and a metal foil.

In the above described embodiment, although, the grounding spring 46b is configured as a member having the configuration different from that of the grounding spring 46a, the grounding spring 46b is configured as a member having the same configuration as that of the grounding spring 46a. As a result, the external size of the image reading apparatus 1 having the housing 49 made of resin can further be made smaller.

In the above described embodiment, although the grounding spring 46a is described to be provided in the scanning region of the scanning unit 41, the grounding spring 46a may be provided outside the scanning region of the scanning unit 41. The grounding spring 46a may be provided in plurality. The number of the grounding springs 46a and 46b and the providing locations can be selected as to be effective in suppressing interference waves according to the relationship between the frequency of the interference waves and the length of the guide shaft 40.

In the above described embodiment, the configuration is exemplified in which one grounding spring 46b of two grounding spring 46a and 46b that are in contact with the guide shaft 40 is disposed outside the scanning region of scanning unit 41 and the other grounding spring 46a is disposed inside the scanning region of scanning unit 41. However, the configuration is not limited to this one. For example, both of two grounding springs 46a and 46b may be disposed inside the scanning region of scanning unit 41. Even with this configuration, the interference waves can be suppressed by grounding the guide shaft 40 without making larger the external size of the apparatus.

In the above described embodiment, the configuration is exemplified in which one grounding spring 46b of two grounding spring 46a and 46b that are in contact with the guide shaft 40 is in contact with one end surface of the guide shaft 40 in the longitudinal direction and the other grounding spring 46a is in contact with the surface along the scanning direction of the guide shaft 40. However, the configuration is not limited to this one. For example, two grounding springs may be disposed on the surface along the scanning direction of the guide shaft 40 such that one grounding spring of the two grounding springs is in contact with a first position of the surface along the scanning direction of the guide shaft and the other grounding spring is in contact with a second position different from the first position of the surface along the scanning direction of the guide shaft. Even with this configuration, the interference waves can be suppressed by grounding the guide shaft 40 without making larger the external size of the apparatus.

In the above described embodiment, the configuration is exemplified in which the apparatus main body 100A of the image forming apparatus 100 is provided with control unit 130 having the grounding point 131 as a reference potential. However, the configuration is not limited to this one. The reading apparatus main body 3 of the image reading apparatus 1 may be provided with a control unit having a grounding point as a reference potential and the grounding point of the control unit may be electrically connected to the grounding springs 46a and 46b to ground the guide shaft 40.

In the above described embodiment, the image forming apparatus having the image reading apparatus is exemplified and the copying machine is exemplified as the image forming apparatus. The present disclosure is not limited to this configuration. For example, other image forming apparatuses such as a facsimile, other image forming apparatuses such as a multi-functional machine with these functions combined, or other image reading apparatus such as a scanner may be exemplified. The same effect can be obtained by applying the present disclosure to these image forming apparatuses and the image reading apparatuses.

In the above described embodiment, the image forming apparatus is exemplified that uses the intermediate transfer member, transfers toner images of respective colors onto the intermediate transfer member in a sequentially superimposed manner, and transfers the toner images borne on the intermediate transfer member onto a sheet (recording material) as a recording subject in a batch. However, the configuration is not limited to this one. An image forming apparatus may be exemplified that uses a recording material bearing member, and transfers the toner images of respective colors onto a recording material borne on the recording material bearing member in a sequentially superimposed manner. The same effect can be obtained by applying the present disclosure to the image reading apparatus of the image forming apparatus.

In the above described embodiment, the electrophotographic system is used as the recording system. However, the configuration is not limited to this one. Other recording systems such as the ink jet system may be used.

According to this disclosure, the guide shaft can be grounded without making larger the external size of the image reading apparatus having a housing made of resin.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-102604, filed Jun. 26, 2024, which is hereby incorporated by reference herein in its entirety.

What is claimed is:

1. An image reading apparatus comprising:
a transparent plate on which a document is placed;
a reading unit configured to read the document placed on the transparent plate while moving in a scanning direction;
a holding member configured to hold the reading unit;
a guide shaft configured to support the holding member such that the holding member can move in the scanning direction;
a housing configured to accommodate the reading unit and the guide shaft, the housing being made from resin, the transparent plate being placed on an upper surface of the housing; and
a grounding member configured to ground the guide shaft by being in contact with the guide shaft,
wherein the holding member includes a sliding portion that fits to the guide shaft and is slidable in the scanning direction with respect to the guide shaft, the sliding portion having a groove-like shape whose lower portion in a vertical direction is opened, and
wherein, as viewed in the scanning direction, the grounding member is in contact with the guide shaft in an opened portion of the sliding portion.

2. The image reading apparatus according to claim 1,
wherein the grounding member is a torsion coil spring made of metal.

3. The image reading apparatus according to claim 1,
wherein the grounding member is pressed on the guide shaft with a predetermined force.

4. The image reading apparatus according to claim 1, further comprising a support member configured to support the grounding member,
wherein the grounding member is an elastic member having electric conductivity, and
wherein the support member restricts the grounding member from being tilted such that the contact between the grounding member and the guide shaft is released.

5. The image reading apparatus according to claim 1, further comprising a control unit having a grounding point as a reference potential,
wherein the grounding point is electrically connected to the grounding member.

6. The image reading apparatus according to claim 1,
wherein the grounding member is a first grounding member configured to ground the guide shaft by being in contact with a surface of the guide shaft along the scanning direction, and
wherein the image reading apparatus further comprises a second grounding member configured to ground the guide shaft by being in contact with one end surface of the guide shaft in the scanning direction.

7. The image reading apparatus according to claim 6,
wherein the first grounding member is in contact with the guide shaft inside a region in which the reading unit scans and reads the document, and
wherein the second grounding member is in contact with the guide shaft outside the region in which the reading unit scans and reads the document.

8. The image reading apparatus according to claim 6, further comprising a driving unit configured to drive the reading unit,
wherein the driving unit is accommodated in the housing such that the driving unit is provided at one end portion side of the guide shaft in the scanning direction, and
wherein the second grounding member is in contact with an end surface of the guide shaft at a side where the driving unit is provided.

9. The image reading apparatus according to claim 1,
wherein the grounding member is in contact with the guide shaft inside a region in which the reading unit scans and reads the document.

10. The image reading apparatus according to claim 9,
wherein, inside a region where the reading unit scans and reads the document, the grounding member has a grounding member configured to ground the guide shaft by being contact with a first position of a surface of the guide shaft along the scanning direction and a grounding member configured to ground the guide shaft by being contact with a second position of the surface of the guide shaft along the scanning direction, the second position being different from the first position.

11. The image reading apparatus according to claim 1,
wherein the guide shaft is made of metal.

12. The image reading apparatus according to claim 1,
wherein the sliding portion includes a first opposing portion and a second opposing portion that is opposed to the first opposing portion via the guide shaft, the first opposing portion being separated from the second opposing portion such that a surface along the scanning direction of the guide shaft is opened, and
wherein the grounding member is in contact with the surface along the scanning direction of the guide shaft that is opened between the first opposing portion and the second opposing portion.

13. The image forming apparatus comprising:
an image forming portion configured to form an image on a sheet;
a transparent plate on which a document is placed;
a reading unit configured to read the document placed on the transparent plate while moving in a scanning direction;
a holding member configured to hold the reading unit;
a guide shaft configured to support the holding member such that the holding member can move in the scanning direction, and to guide the holding member in the in the scanning direction;
a housing configured to accommodate the reading unit and the guide shaft, the housing being made from resin, the transparent plate being placed on an upper surface of the housing; and
a grounding member configured to ground the guide shaft by being in contact with the guide shaft,
wherein the holding member includes a sliding portion that fits to the guide shaft and is slidable in the scanning direction with respect to the guide shaft, the sliding portion having a groove-like shape whose lower portion in a vertical direction is opened, and
wherein, as viewed in the scanning direction, the grounding member is in contact with a surface of the guide shaft along the scanning direction in an opened portion of the sliding portion.
